(19) United States
(12) Patent Application Publication
(10) Pub. No.: US 2025/0144684 A1
(43) Pub. Date: May 8, 2025

(54) SYSTEMS AND METHODS FOR SOIL REMEDIATION

(71) Applicant: Austere Environmental, Inc., Golden, CO (US)

(72) Inventors: Curtis Anthony Purrington, Golden, CO (US); Daniel Kenneth Johnson, Golden, CO (US)

(73) Assignee: Austere Environment, Inc., Golden, CO (US)

(21) Appl. No.: 18/910,641

(22) Filed: Oct. 9, 2024

Related U.S. Application Data
(60) Provisional application No. 63/595,685, filed on Nov. 2, 2023.

(51) Int. Cl. B09C 1/06

(52) U.S. Cl. CPC B09C 1/06; B09C 2101/00

(57) ABSTRACT

The disclosure comprises a system for restoring a contaminated soil, the system comprising: a first vessel configured to receive the contaminated soil; an agitator configured to disturb the contaminated soil; a heat source configured to heat the contaminated soil; and a vacuum pump coupled to the first vessel, wherein the coupling enables an evaporated contaminant to escape from the first vessel. The disclosure further comprises a method for restoring a contaminated soil, the method comprising: loading the contaminated soil into a first vessel; applying a heat to the contaminated soil in the first vessel; applying a vacuum pump to the first vessel to reduce a pressure within the first vessel; maintaining the heat and the reduced pressure for a defined duration; agitating the contaminated soil during the defined duration; and removing an evaporated contaminant from the first vessel.

The following is an application for patent under 35 U.S.C. 111(a). The application claims priority to U.S. Provisional Application No. 63/595,685 filed Nov. 2, 2023.

### TECHNICAL FIELD

The disclosure relates to systems and methods for removing contaminates from soil. More specifically, this disclosure relates to systems and methods that use heat, pressure and/or agitation to separate contaminates from soil.

### BACKGROUND

Soil contaminated by hydrocarbons can negatively impact soil health, rendering it unusable. This contamination can occur through various means, such as leaks, vehicle accidents, and other spills. Contamination can also occur through the generation of solid waste through industrial processes such as drilling operations or mineral extraction processes. Contaminants that remain in soil can produce adverse effects on the environment, and result in a loss of use of both the contaminated soil and the contaminants.

Traditional methods of dealing with contaminated soil include soil mixing (diluting the contaminated soil with clean soil or another medium to reach acceptable contamination levels), incinerating the contaminated soil, or dumping the contaminated soil in a landfill. These methods have undesirable effects, including the generation of waste, hazardous byproducts, and logistical inefficiencies. Additionally, none of these actions restore the contaminated soil or contaminants.

In many locations where soil contamination occurs, such as a roadside or remote work site, current methods for contamination clean-up may be impractical, expensive, ineffective, or hazardous. This leaves a need for a restoration method that is time efficient, economical, transportable, and safe.

### SUMMARY

The disclosure describes a system for restoring contaminated soil, which according to some embodiments includes a vessel configured to receive contaminated soil. An agitation source can be coupled to the vessel to agitate the contaminated soil. A heat source can apply heat to the vessel to heat the contaminated soil. The vessel can be coupled to a vacuum pump or compressor, wherein the coupling enables an evaporated contaminant to escape from the vessel. In some embodiments, the vacuum pump is a dry vacuum pump.

In some embodiments, the vacuum pump is coupled to the vessel and to a volatile collection tank. In some embodiments, a volatile output line is coupled to the vacuum pump to connect it to the vessel and to the volatile collection tank, wherein the volatile output line preserves vacuum pressure in the system.

In some embodiments, an agitation source is coupled to the vessel and configured to agitate the contaminated soil, wherein the agitation source is comprised of a motor, gearbox, and mixing apparatus. In some embodiments, the mixing apparatus is comprised of the vessel and vessel fins and mixes the contaminated soil through rotation.

The disclosure describes a system for removing contaminants from soil, which according to some embodiments includes a vessel configured to receive contaminated soil. An agitation source can be configured to agitate the contaminated soil load while a heat source is configured to heat the contaminated soil. A vacuum pump can be coupled to the vessel, wherein the coupling enables an evaporated contaminant to escape from the vessel.

In some embodiments, the internal temperature of the vessel is monitored with at least one temperature sensor and the internal pressure of the system is monitored with at least one pressure sensor.

In some embodiments, the vessel is insulated, wherein the insulation is comprised of an insulating sheath partially surrounding the vessel and preserves heat within the system.

In some embodiments, a control panel facilitates the operation of the system by storing information gathered from temperature and pressure sensors, and initiating operations of the system.

In some embodiments, the system is modular and self-contained to allow for transportation on a truck or trailer.

The disclosure describes a method for restoring hydrocarbon contaminated soil, which according to some embodiments includes loading contaminated soil into a vessel. A vacuum pump is applied to the vessel to reduce pressure within the vessel. The contaminated soil within the vessel is heated and agitated at a reduced pressure. Heat, pressure, and agitation are applied to the contaminated soil for a duration sufficient to remove contaminants from the soil. Evaporated contaminants can then be removed from the vessel.

In some embodiments, the contaminated soil is loaded to a volume sufficient to facilitate the volatilization of contaminants, which in some embodiments is one third to one half of the volume of the vessel.

In some embodiments, applying the vacuum pump to the system causes a reduction of the pressure of the system to a first defined pressure.

In some embodiments, applying heat to the vessel includes increasing the temperature to a first defined temperature.

In some embodiments, the pressure of the system decreases as contaminants volatilize.

In some embodiments, the volatilized contaminant is condensed to form a liquid contaminant in a second vessel.

In some embodiments, the reduced pressure is applied using a dry vacuum pump. The dry vacuum pump is fluidly coupled to a first vessel and a second vessel and causes the evaporated contaminant to be transported from the first vessel to the second vessel.

The disclosure comprises a system for restoring a contaminated soil, the system comprising: a first vessel configured to receive the contaminated soil; an agitator configured to disturb the contaminated soil; a heat source configured to heat the contaminated soil; and a vacuum pump coupled to the first vessel, wherein the coupling enables an evaporated contaminant to escape from the first vessel.

The agitator may disturb the soil by rotation. The system may further comprise an insulation on the first vessel. The first vessel may comprise at least one fin that protrudes into the first vessel. The first vessel may comprise at least one temperature sensor. The first vessel may comprise at least one pressure sensor. The first vessel may comprise a control system configured to coordinate operation of the system. The control system may be configures to monitor and control the internal temperature and/or internal pressure of the system over time. The vacuum pump of the system may be a dry pump. Further, the system may comprise a second vessel coupled to the vacuum pump to contain the evaporated contaminant.

The disclosure comprises a system for removing contaminants from a contaminated soil, the system comprising: a first vessel configured to receive the contaminated soil and to agitate the contaminated soil; a heat source configured to heat the contaminated soil; and a vacuum pump coupled to the first vessel, wherein the coupling enables an evaporated contaminant to escape from the first vessel. The vacuum pump may comprise a dry vacuum pump dynamically sealed to the first vessel. Further the dry vacuum pump is coupled to the first vessel and a second vessel and causes the evaporated contaminant to be transported from the first vessel to the second vessel.

The disclosure further comprises a method for restoring a contaminated soil, the method comprising: loading the contaminated soil into a first vessel;

applying a heat to the contaminated soil in the first vessel; applying a vacuum pump to the first vessel to reduce a pressure within the first vessel; maintaining the heat and the reduced pressure for a defined duration; agitating the contaminated soil during the defined duration; and removing an evaporated contaminant from the first vessel.

The method may comprise applying the vacuum pump to the first vessel to reduce the pressure within the first vessel comprises reducing the pressure to 0.001 Torr. Further the method may comprise wherein applying the heat to the contaminated soil in the first vessel comprises causing the contaminated soil to be heated to a temperature equal to or greater than 325 Kelvin. The method may comprise wherein the evaporated contaminant is condensed to form a liquid contaminant in a second vessel. The method may comprise wherein agitating the contaminated soil during the defined duration causes the contaminated soil to turnover, wherein turnover maximizes the volatilization of the contaminant out of the soil forming the evaporated contaminant during the defined duration. The method may comprise wherein: the reduced pressure is applied using a dry vacuum pump; and the dry vacuum pump is fluidly coupled to the first vessel and a second vessel and causes the evaporated contaminant to be transported from the first vessel to the second vessel.

### BRIEF DESCRIPTION OF THE DRAWINGS

FIG. 1 shows a system for restoring contaminated soil according to one embodiment.

FIG. 2 shows a mechanical schematic representation of the system of

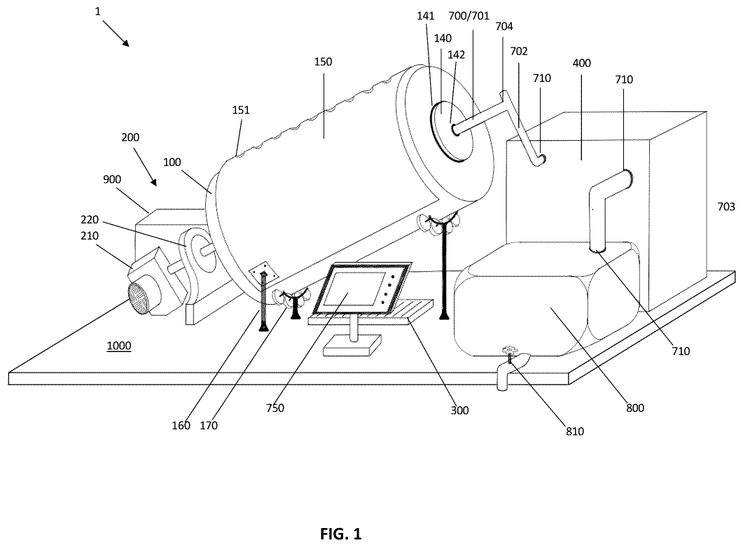

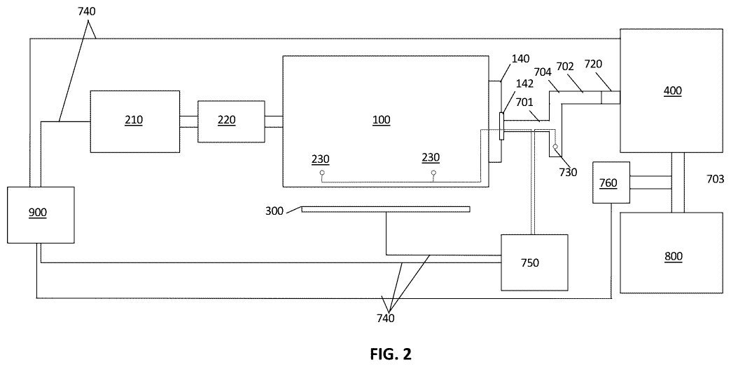

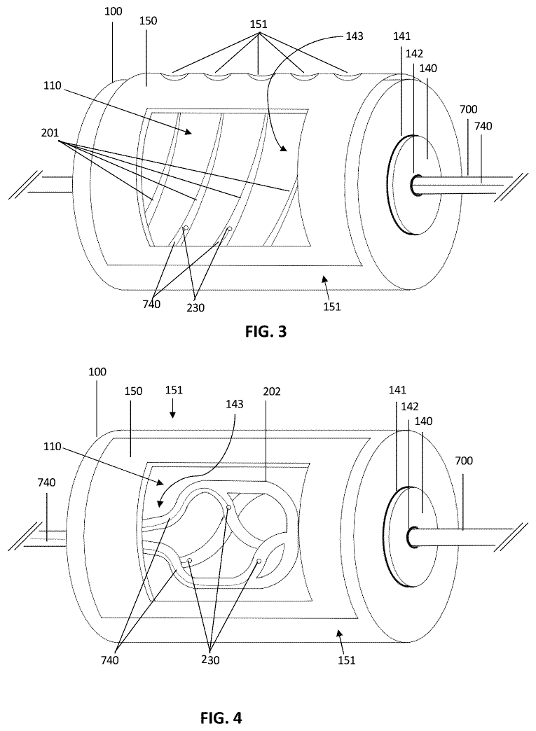

FIG. 1 according to some embodiments.

FIG. 3 shows a partial cross section of the vessel of FIG. 1 with agitation fins, according to some embodiments.

FIG. 4 shows a partial cross section of the vessel of FIG. 1 with a rotating agitation arm, according to another embodiment.

FIG. 5 shows a flow chart representing an operating sequence for the soil remediation system of FIG. 1 according to some embodiments.

FIG. 6 shows a flow chart illustrating heat and vacuum conditions at nodes of the operating sequence of FIG. 5, according to some embodiments.

Before explaining the disclosed embodiments of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION

### Terms

As used herein, “distinct” or “different” refers to a separate entity or structure. For instance, wherein in a structure is already recited and a distinct or different structure is recited, the different structure represents a second, separate structure.

As used herein, “substantially” is defined as to a great or significant extent, for the most part, or essentially. For example, a substantially full vessel in a preferred embodiment would be 98% to 100% full. In other terms, the void space of the vessel being less 2%, or less than 1% of the total capacity of the vessel. As used herein, “about” is defined as meaning almost or nearing a certain value. For example, an about or almost full vessel in a preferred embodiment would be at least 95% full. In other terms, the void space of the vessel being less than 5% empty.

### Description

With reference to FIG. 1, and following FIGS. 2-6, FIG. 1 shows a soil remediation system 1 according to an embodiment of the present disclosure. The soil remediation system 1 includes a vessel 100, agitation source 200, heat source 300, vacuum pump 400, volatile output line 700, volatile collection tank 800, and control panel 750, according to some embodiments. Throughout this disclosure soil is given as an example. The systems and methods described herein can apply to other granular media including drill cuttings and mine tailings. The systems and methods described herein can also apply to naturally occurring media that has not undergone a contamination event, such as naturally oily soil or sand deposits.

As illustrated in FIG. 1, the system 1 permits contaminated soil to be loaded into a vessel 100. Heat and/or agitation may be applied to the contaminated soil in the vessel 100 and/or to the vessel itself, in order to volatize contaminants. A vacuum pump assembly 400 facilitates removal of the volatized contaminants from the vessel 100, and a collection assembly 800 condenses and collects the volatized contaminants for further disposition and/or transport. A control system 750 facilitates the operation of the system 1 by analyzing and/or storing information gathered from temperature sensors 230 and pressure sensors 730, and initiating the different stages of operation, as shown in FIG. 4. For example, the control system 750 can receive temperature data from one or more temperature sensors and/or pressure data from one or more pressure sensors and analyze the data to determine control parameters for the system. The control parameters can include how much heat to apply, when to start and stop rotation, vacuum cycles and/or when to end a contamination removal process. The control system 750 can store information temporarily or permanently. In some embodiments, the control system can include some components that are integrated with the vessel 100, agitation source 200, motor 210, vacuum pump 400, volatile output line 700, and volatile collection tank 800, and may transmit data to a remote system that can monitor and/or control the soil remediation system 1. For example, a remote computer, cloud-based system, an application on a phone or tablet, or combination thereof.

As shown in FIG. 1, heat can be applied from a heat source 300, which can include a propane burner, natural gas burner, electrical heaters, or process heat reclamation. The heat source 300 of the soil remediation system 1 supplies heat to the contaminated soil load in the vessel 100. The heat source 300 heats contaminated soil through one or more of convective heating, conductive heating, and/or radiative heating. According to one embodiment, the heat source 300 is a propane or natural gas burner located underneath the vessel 100. The vessel 100 may be constructed of or include a heat conductive material that thermally conducts the heat from the source to the contaminated soil. In some embodiments, the vessel 100 has an insulating sheath 150 including a thermal shroud that at least partially encloses and/or encircles and/or surrounds the vessel 100. In some cases, the shroud includes one or more openings 151 that facilitate heat transfer from the heat source to the contaminated soil within the vessel.

The heat can be applied in other ways, for example chemically, geothermally, electrically, and/or in any other known manner. Any source of heat can be employed to volatize contaminants out of the contaminated soil load. The vessel cavity FIG. 3, 110 and/or the whole vessel 100 can be heated through resistive heating or otherwise, where electrical conductors may be attached to the vessel 100, e.g., embedded in the vessel wall, be connected to or otherwise integrated with the mixing apparatus, be positioned on the inner or outer surface of the vessel 100, and/or otherwise attached to the vessel 100 to cause the temperature of the vessel cavity 110 to increase. Alternative fuel heat sources include natural gas, methane, or propane. Alternative electric heat sources include resistive patch heaters, inductive heaters, or radiative heaters. Additionally, the heat source can come from process heat or concentrated solar.

As illustrated in FIG. 3, agitation of the soil in the vessel 100 may be achieved in several ways, for example via rotation of the vessel 100, stirring of the contaminated soil load, shaking of the vessel 100, or using other suitable techniques. According to the embodiments shown in FIGS. 1, 2, 3, and 4, an agitation source 200 is coupled to the opposite end of the vessel 100 from the door 140. As used herein, the term “coupled” is used in its broadest sense to refer to elements which are connected, attached, and/or engaged, either directly or integrally or indirectly via other elements, and either permanently, temporarily, or removably. As shown in FIGS. 1, 3 and 4, the agitation source 200 may be comprised of a motor 210, a gearbox 220, and a mixing apparatus 201/202. The mixing apparatus 201/202 extends into the vessel cavity 110, in some embodiments. In other embodiments, the mixing apparatus 201/202 is located entirely within the vessel cavity 110. The mixing apparatus 201/202 is configured to agitate the contaminated soil load. A generator 900 can provide power to the agitation source 200, the heat source 300, the vacuum pump 400, and the control panel 750.

As shown in FIGS. 1, 3, and 4, the vessel 100 can be cylindrical or another shape capable of containing an open volume within it, and configured along a horizontal, vertical, or otherwise tilted vessel axis. According to the present embodiment, the vessel 100 and vessel cavity 110 can be configured to hold varying amounts of soil. For example, smaller vessels may be used for smaller cleanup sites and larger vessels for larger cleanup sites. In some embodiments where the vessel 100 rotates or is otherwise agitated, roller bearings 170 support the vessel 100 to hold it in place. The vessel 100 may also be held in place by a static fixation on one or both ends. In some embodiments, where the vessel 100 remains static and the contaminated soil load is agitated via a mixing arm FIG. 4, 202 or other type of agitation source inside of the vessel 100, the vessel 100 is supported by static or dynamic support beams.

The vessel 100 is configured to receive contaminated soil into a vessel cavity 110. A door 140 located at one end of the vessel 100 facilitates loading contaminated soil into the vessel cavity 110. Contaminated soil may be loaded into the vessel cavity 110 through the opening when the door 140 is open; contaminated soil that has been loaded into the vessel cavity 110 may be referred to as a contaminated soil load, according to some embodiments. The door 140 may be opened and closed in order to selectively open and/or close the vessel. The door 140 may be a panel hinged to the vessel 100, or fully removable from the vessel 100. A seal 141 around the door 140 allows for the vessel 100 to retain the heat and pressure, e.g., negative vacuum pressure that is applied to the soil remediation system 1.

The vacuum pressure may be applied in several ways, for example inline, where the volatiles are passed through the vacuum pump 400 and to the volatile collection tank 800 or using a condenser (not shown) between the vessel 100 and the vacuum pump 400 to condense and/or collect the volatiles in the volatile collection tank 800 before reaching the vacuum pump 400. The vessel 100 is coupled to the vacuum pump 400. According to some embodiments, the vacuum pump 400 may be one or more vacuum pumps or compressors. According to some embodiments, the vacuum pump 400 is a dry vacuum pump. The dry vacuum pump used may be, for example, an industrial dry vacuum pump, a chemical duty dry vacuum pump, or a dry scroll vacuum pump. A volatile output line FIGS. 3-4, 700 long enough for the placement of one or more filter(s) 720 connects the vacuum pump 400 to the vessel 100. FIG. 1 shows the vacuum 400 coupled to the door 140 of the vessel 100. The volatile output line 700 mounted to the door 140 can be flexible in order to bend when the door opens and closes or is otherwise displaced from its seal on the vessel. The vacuum pump 400 can be coupled to the door 140 or other location on the vessel 100 with a rotational dynamic seal 141 which allows the whole vessel 100 and door 140 to rotate without the vacuum pump 400 rotating.

Volatile compounds may be condensed and/or collected for ease of disposition and/or further transport. The vacuum pump 400 is coupled to the vessel 100 and to a volatile collection tank 800. The vacuum pump 400 can be coupled to the volatile collection tank 800 via a volatile output line 700. The volatile output line 700 can be coupled to a cooling apparatus 760. The cooling apparatus 760 can be configured to facilitate the condensation of volatilized contaminants. In some embodiments, the volatile collection tank 800 is configured to allow for the collection of contaminants through a release valve 810. In some embodiments, the volatile collection tank 800 can be removed from the soil remediation system 1 for the removal of collected contaminants or the replacement of the volatile collection tank 800. The removable volatile collection tank is coupled to the vacuum pump 400 or the volatile output line 700 with a sealed gasket 710 that allows for the system 1 to be pressurized.

The system 1 is relatively compact and can be transported on a truck or bed 1000. The system 1 is modular and self-contained to allow for transportation to the location of the contaminated soil, further permitting ex situ soil remediation on-site for reduced relocation costs and effort. The system 1 includes materials that are portable, modular components that when constructed together form the system.

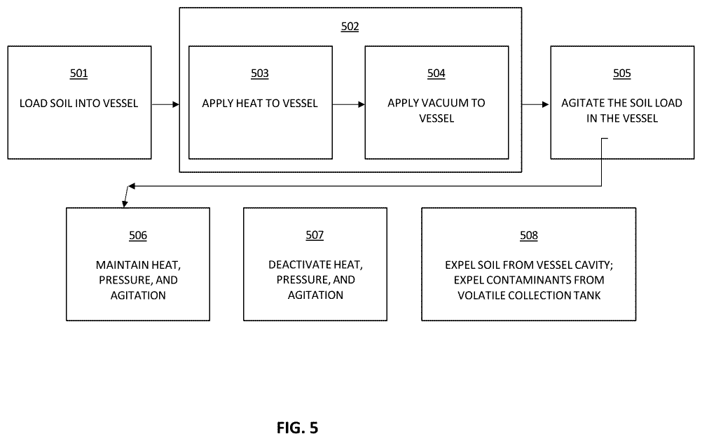

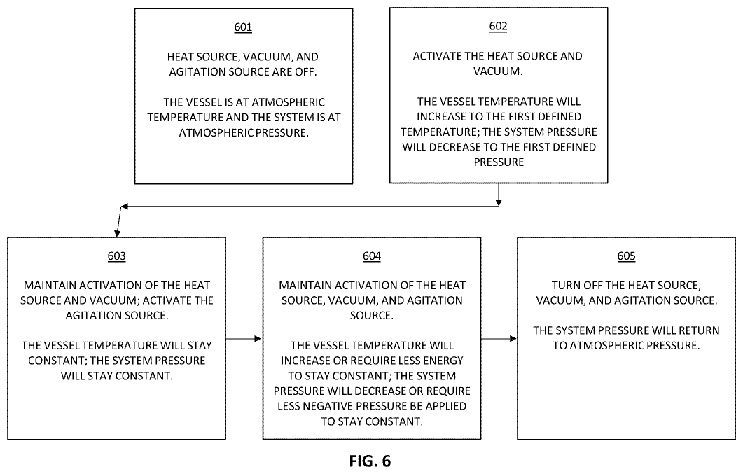

FIG. 2 shows a system diagram of the soil remediation system 1 depicted in FIG. 1, further depicting the vessel 100, agitation source 200, heat source 300, vacuum pump 400, volatile output line 710, volatile collection tank 800, control panel 750, and the connection between the system components.

The soil remediation operating sequence of FIGS. 4 and 5 use a combination of heat, pressure, and agitation to remove volatilized contaminants from the contaminated soil load. A generator 900 that is connected to the soil remediation system 1 can provide power to the heat source 300, vacuum pump 400, agitation source 200, and control panel 750. In some embodiments, the soil remediation system 1 can be powered via alternative means, for example connection to a vehicle engine, connection to a power grid, or through renewable energy sources like solar or wind.

As shown in FIGS. 1-4, in some embodiments, the agitation source 200 is comprised of a motor 210, gearbox 220, and mixing apparatus. Possible types of mixing apparatuses include vessel fins 201 and/or a mixing arm 202 as described in FIGS. 3 and 4. The mixing apparatus can contain one or more temperature sensors 230 that sends temperature information to the control system 750 about the temperature in the vessel 100. Electrical wiring 740 that connects the temperature sensor 230 to the control panel 750 enables the control panel 750 to read temperature information. According to some embodiments, the electrical wiring 740 can be routed and secured along the outside of the vessel 100 to a slipring connector 142 located at the vessel axis, to permit electrical connections to be maintained as the vessel rotates about an axis or otherwise moves for agitation. In some embodiments, information from the temperature sensors 230 can be transmitted wirelessly.

As shown in FIGS. 3, and 4 the vessel cavity 110 is configured to receive and temporarily hold the contaminated soil load. In some embodiments, the vessel cavity 110 is not filled completely with the contaminated soil load. The remaining empty volume in the loaded vessel cavity 110 facilitates mixing and creates space for volatilized contaminants to evaporate out of the contaminated soil load as the contaminated soil load is agitated by the mixing apparatus. The vessel cavity 110 can hold varying amounts of the contaminated soil load. The amount of the contaminated soil load in the vessel cavity 110 may affect the cycle time and/or the number of volatilized contaminants that evaporate out of the contaminated soil load. Accordingly, the amount of contaminated soil loaded into the vessel cavity 110 can be based on several different factors, including the number of contaminants to be removed from the soil and the time required to remove contaminants. According to some embodiments, the vessel cavity 110 is filled to at least about 25%, or at least about 30%, or at least about 35%, or at least about 45%, or at least about 50%, or at least about 55%, or at least about 60% of its volume, or more.

As shown in FIGS. 3-4, volatilized contaminants can be pulled out of the vessel cavity 110 and vessel 100 through a volatile output line 700 via pressure applied to the soil remediation system 1. The volatile output line 700 couples to the vessel 100. In some embodiments, the coupling is a gasket 141 and slipring connector 142 that allows the vessel to rotate or otherwise be agitated separately from the volatile output line. In some embodiments, the gasket 141 is a centering ring gasket to preserve the vacuum seal between the vessel 100 and volatile output line 700. In some embodiments, the volatile output line 700 couples to the vessel 100 along the vessel rotation axis which further allows the vessel 100 to rotate and the volatile output line 700 to stay static, preserving the integrity of the electrical wiring 740 that passes through the coupling. The slipring connector 142 can be the same slipring connector that the electrical wiring 740 passes through. The connection between the volatile output line 700 and the vessel 100 can be on the door 140.

As shown FIGS. 1-4, the volatile output line 700 can be made of one or more manifold lines, where the volatile output line connects the vessel 100 to the vacuum pump 400 and the volatile collection tank 800. According to one embodiment, the volatile output line 700 includes a volatile output manifold line 701 between the vessel and a T-line 704, a volatile output manifold line 702 between the T-line 704 and vacuum pump 400, a volatile output manifold line 703 between the vacuum pump 400 and the volatile collection tank 800, and a gasket 710 connection between each other part.

A pressure sensor FIG. 2, 730 is located along the volatile output line 700 between the vessel 100 and the vacuum pump 400. According to some embodiments, the pressure sensor 730 is a transducer convection gauge pressure sensor. In some embodiments, the pressure sensor 730 is located in one branch of the T-line 704 that is located between volatile output manifold line 701 and volatile output manifold line 702. A filter 720 located between the pressure sensor 730 and the volatile output line 700 or around the pressure sensor 730 protects the pressure sensor 730 from exposure to volatilized contaminants. In other embodiments, the pressure sensor 730 can be positioned at other locations of the system 1. For example, one or more pressure sensors 730 may be positioned in the vessel 100 or be configured to measure a pressure within the vessel 100. The pressure sensor 730 is configured to send information to the control system 750, which information can be transmitted via a second set of electrical wiring 740, or wirelessly.

In some embodiments, the volatile output line 700 is coupled to the vacuum pump 400 via a seal 710 to preserve the vacuum pressure in the system 1. The seal 710 can be created with a gasket (not shown). In some embodiments, there is one or more filters 720 between the vessel cavity 110 and the vacuum pump 400 along the volatile output line 700 to protect the vacuum pump 400 from damage by the contaminated soil load. In some embodiments, the filter 720 is in volatile output manifold line 702.

The vacuum pump 400 can be coupled to the volatile collection tank 800. In some embodiments, the vacuum pump 400 is coupled to the volatile output line 700 which is also coupled to the volatile collection tank 800, where the presence of the volatile output line 700 enables the volatilized contaminants to cool and then condense before reaching the volatile collection tank 800. In some embodiments, this is volatile output manifold line 703. The coupling between the vacuum pump 400, volatile collection tank 800, and volatile output line 700 is a seal 710. According to some embodiments, the volatile output line 700 can be configured to house the cooling apparatus 760 upstream of the volatile collection tank 800 which assists the condensation of volatilized contaminants for their collection as condensed contaminants in the volatile collection tank 800. In other embodiments, the volatile output line 700 can be configured to house the cooling apparatus 760 downstream of the volatile collection tank 800.

The control system 750 can be configured to display the progress of the system, including but not limited to general status indications, or specific readings of the temperature and pressure within the system.

FIGS. 3 and 4 show the vessel 100 with a partial cross section open into the vessel cavity 110. In some embodiments, the vessel 100 is a cylindrical shape with a motor 210 and gearbox 220 on one end, a door 140 and volatile output line 700 on another end, and a vessel cavity 110 inside. In some embodiments, the vessel 100 is partially surrounded by an insulating sheath 150. The insulating sheath 150 is made of an insulating metal such as steel, or a combination of insulating materials such as fiberglass.

FIG. 3 shows an embodiment where the insulating sheath 150 is one thermal shroud contoured around the vessel 100 with an opening 151 located at the bottom of the vessel 100 to expose the vessel 100 to the heat source 300, and additional openings 151 on the top side of the insulating sheath. In some embodiments, one or more openings 151 on the opposite side of the vessel 100 from the heat source 300 to facilitate a flow of hot air around the vessel 100.

FIG. 4 shows an embodiment where the insulating sheath 151 is made of two thermal shrouds contoured around the sides of the vessel 100, and which leave the bottom side of the vessel 100 exposed to a heat source 300 and the top side of the vessel exposed for propane gas to escape. The vessel 100 can be insulated in other ways, for example a fixed insulating sheath completely surrounding the vessel 100 that can rotate with the vessel 100, or a fixed insulating sheath around the vessel 100 and heat source 300 together. There can be a space between the insulating sheath 151 of FIGS. 3 and 4 and the vessel to enable hot gases to flow between the insulating sheath 151 and the vessel 100.

The agitation source 200 is comprised of the motor 210, gearbox 220, and mixing apparatus 201, 202. FIG. 3 shows an embodiment where the mixing apparatus is comprised of the vessel 100 and vessel fins 201 and mixes the contaminated soil load by rotating. The vessel fins 201 are protrusions from the inside of the vessel wall into the vessel cavity 110. The agitation source 200 consisting of the motor 210, gearbox 220, vessel 100, and vessel fins 201 causes a rotation of the vessel 100, including the vessel cavity 110 and vessel fins 201, around the vessel axis. The rotation of the vessel 100 agitates the contaminated soil load inside the vessel cavity 110 by turning it over. According to some embodiments, the rotation of the vessel 100 occurs at a rate of at least about 1 RPM, or at least about 5 RPM, or at least about 10 RPM, or at least about 15 RPM, or at least about 20 RPM, or at least about 25 RPM, or at least about 30 RPM, or at least about 35 RPM, or at least about 40 RPM, or at least about 45 RPM, or at least about 50 RPM, or at least about 55 RPM, or at least about 60 RPM, or more. The vessel 100 can rotate in full rotations or repetitions of partial rotations in either rotational direction or both rotational directions.

FIG. 4 shows an embodiment where the mixing apparatus 200 is comprised of a mixing arm 202. The mixing arm 202 extends into the vessel cavity 110 and is coupled to the vessel 100 or the door 140 with a dynamic rotational seal 143. Dynamic rotational seals 143 or dynamic seals 143 are used to induce motion between the hardware component and the sealing solution. In dynamic seals the motion can be rotary, as in dynamic rotational seals 143, translatory, reciprocating or oscillating. Effective dynamic seals maintain a balance between the sealing force, minimize the friction and furthermore prevent leakage. According to some embodiments, the mixing arm 202 is a paddle shape, extending to within about 1 cm of the inner diameter of the vessel cavity 110. of the vessel cavity 110 in order to mix the contaminated soil load. In some embodiments, the mixing arm 202 is a whisk shape, spatula shape, or stirring rod with one or more prongs. The agitation source 200 being comprised of the motor 210, gearbox 220, and mixing arm 202 causes a rotation of a mixing arm 202 inside of the vessel cavity 110, which can agitate the contaminated soil load by stirring it. According to some embodiments, the rotation of the mixing arm 202 occurs at substantially 1 RPM. The mixing arm 202 can rotate in full rotations or repetitions of partial rotations in either rotational direction or both rotational directions.

Agitation of the contaminated soil load can further be accomplished via moving the contaminated soil load within the vessel 100 via shaking, stirring, prodding, raking, or otherwise displacing parts of the contaminated soil load within the vessel cavity 110. According to some embodiments, the mixing apparatus being a vibratory mixer causes the vessel 100 to shake.

The temperature of the contaminated soil load is collected via one or more temperature sensors 230. In some embodiments, the temperature sensor 230 is housed inside of the mixing apparatus, which enables a temperature reading to be collected very near the vessel cavity 110 and contaminated soil load while protecting the temperature sensor 230 from exposure to the contaminated soil load. An embedded placement is shown in FIGS. 3 and 4 for illustrative purposes. According to some embodiments, the temperature sensor 230 can be housed inside of the vessel wall or at any other suitable location.

FIG. 3 shows an embodiment where the temperature sensor 230 is a thermocouple embedded inside the vessel fin 201. In some embodiments, electrical wiring 740 connects the thermocouple temperature sensor 230 to the control panel 750. The electrical wiring 740 is routed along the outside of the rotating vessel 100 but inside of the non-rotating insulating sheath 150, to the slipring connector 142 on the door 140. The slipring connector 142 allows the electrical wiring 740 to rotate as the vessel 100 rotates. In other embodiments, the temperature sensor 230 wirelessly transmits measurements to the control system 750.

FIG. 4 shows an embodiment where the temperature sensor 230 is a thermocouple embedded inside the mixing arm 202. In some embodiments, electrical wiring 740 connects the thermocouple temperature sensor 230 to the control panel 750 and is routed through the inside of the mixing arm 202 to a slipring connector where the mixing arm 202 meets one end of the vessel 100. The slipring connector allows rotation of the electrical wiring 740 as the mixing arm 202 rotates.

FIG. 5 shows an operating sequence of the soil remediation system 1 depicted in FIGS. 1 and 2, according to some embodiments.

In Step 501, contaminated soil is loaded into the vessel 100 to become the contaminated soil load, as explained in FIG. 1. Contaminated soil can be loaded into the vessel 100 through a manual and/or mechanical process, for example shoveling, a mechanical loader, or a dump truck. In some embodiments, the contaminated soil is loaded through the door 140. In some embodiments, a funnel is used to facilitate loading of contaminated soil through the door 140. According to some embodiments, the contaminated soil is loaded to about half the volume of the vessel cavity 110. In some embodiments, the contaminated soil is loaded to about one third the volume of the vessel cavity 110. In other embodiments, the contaminated soil is loaded to a volume of the vessel cavity 110 requisite to support effective volatilization of contaminants from the contaminated soil load.

In Step 503, the heat source 300 of the soil remediation system 1 supplies heat to the contaminated soil load in the vessel 100. The internal temperature of the vessel 100 can affect the volatilization rate and/or the amount of contaminant that is volatilized. Higher temperatures volatilize more contaminants and/or volatilize contaminants at a faster rate. However, the volatilization of contaminants and the rate of volatilization are also dependent on the pressure level created by the vacuum pump 400 because generally lower pressures and higher temperatures lead to more volatilization. The internal temperature of the vessel 100, the vacuum pump 400, and the mixing apparatus can all be adjusted based on the amount or type of contaminant that needs to be removed from the soil for the contaminated soil to be considered contaminant free, or clean. In some embodiments, the temperature inside the vessel 100 may be increased to about 325 Kelvin. In some embodiments, the temperature inside the vessel 100 is increased to a temperature higher than 325 Kelvin. The target temperature that the system 1 is heated to can vary depending on the contaminants loaded into the vessel, and their boiling, or vaporization points.

In Step 504, the pressure in the system 1 is reduced with the vacuum pump 400, where a lower pressure promotes the removal of volatized contaminants from the vessel 100. In some embodiments, the pressure in the vessel 100 and volatile output line 700 are reduced to at least about, or substantially, 0.001 Torr, or less than 0.001 Torr. The target pressure of the vessel 100 and volatile output line 700 can vary depending on the contaminants loaded into the vessel. In some embodiments, the pressure inside the vessel is reduced below about 0.001 Torr. According to some embodiments, a dry vacuum pump can be used to maintain adequate pressure in the vessel 100.

According to some embodiments, the application of heat in Step 503 and pressure in Step 504 may be done concurrently as Step 502. In some embodiments, Step 503 and Step 504 are completed consecutively, in either order.

In Step 505, the contaminated soil load in the vessel 100 is agitated using the mixing apparatus described in FIGS. 3 and 4. Agitation efficiently facilitates removal of the volatized contaminants from the contaminated soil load by facilitating the transfer of heat to the entire soil load and allowing volatized contaminants to escape as they are brought to the top or exposed part of the contaminated soil load. Agitation of the contaminated soil load may be achieved in several ways, for example via rotation, stirring, mixing, and/or shaking, as described in FIGS. 3 and 4.

In Step 506, heat, pressure, and agitation are maintained using the heat source 300, vacuum pump 400, and agitation source 200, respectively. As agitation is maintained, new subsections of the contaminated soil load are exposed to the empty space of the vessel cavity 110, according to some embodiments. This allows for contaminants to efficiently volatize out of the contaminated soil load. In some embodiments, the vessel 100 is maintained at a temperature of about 325 Kelvin and the system 1 is maintained at a pressure of about 0.001 Torr while the contaminated soil load is agitated by the agitation source 200. In other embodiments, the vessel 100 is maintained at a temperature higher than 325 Kelvin and/or the system 1 is maintained at a pressure lower than 0.001 Torr while the contaminated soil load is agitated by the agitation source 200.

As an effect of the combination of heat, pressure, and agitation maintained in Step 506, as described by FIG. 6, contaminants volatize out of the contaminated soil load and into the empty volume in the vessel cavity 110. In some embodiments, as contaminants volatize out of the contaminated soil load, the vessel cavity 110 temperature and pressure are maintained. As described in FIG. 6, in some embodiments, when the temperature can be maintained without further heat input, then the contaminant is sufficiently volatized. In some embodiments where there is more than one contaminant in the loaded soil, the temperature can be further increased to volatize a second contaminant with a higher condensation point. This increase in temperature can be repeated to volatize contaminants individually, according to some embodiments.

The volatilized contaminants that result from Step 506 are condensed and/or collected. According to some embodiments, the contaminants are collected in a volatile collection tank 800. In some embodiments, volatile collection is facilitated by the condensation of volatilized contaminants as a result of a cooling apparatus 760.

In Step 507, the heat source 300, vacuum pump 400, and agitation source 200 are all turned off or deactivated from application to the vessel 100 and/or the system 1. As a result, the contaminated soil load begins to return to atmospheric temperature, and the system 1 begins to return to atmospheric pressure. According to some embodiments, in Step 508, the remediated soil can be expelled from the vessel cavity 110 and the condensed contaminants can be removed from the volatile collection tank 800 for further disposition and/or transport.

In some embodiments, the volatile collection tank 800 is configured to allow for the collection of contaminants through a release valve 810. In some embodiments, the volatile collection tank 800 can be removed from the soil remediation system 1 for the removal of collected contaminants or the replacement of the volatile collection tank 800. The volatile collection tank 800 is coupled to the vacuum pump 400 or the volatile output line 700 with a sealed gasket 710 that allows for the system 1 to be pressurized.

FIG. 6 shows a flow chart depicting the temperature and pressure conditions at different stages throughout the operating sequence of FIG. 5, according to some embodiments.

In Stage 601, corresponding with Step 501 of FIG. 5, the heat source 300, vacuum pump 400, and agitation source 200 are not applied to the system 1 or vessel 100. In some embodiments, the vessel 100 is at the same temperature and pressure as the surrounding atmosphere. In some embodiments, one or more temperature sensors 230 detects temperature within the vessel 100, or the vessel wall or mixing apparatus, and/or of the volatile output line 700, one or more pressure sensors 730 detects pressure within the vessel 100 and/or the volatile output line 700. According to some embodiments, the temperature sensor 230 and the pressure sensor 730 communicate with the control system 750, as described in FIG. 2. According to some embodiments, the control system 750 may indicate the temperature and/or pressure of the system 1 and/or vessel 100. In some embodiments, the control panel 750 can indicate the temperature or pressure of the system 1 through the display of a temperature and/or pressure range, a status bar to represent temperature or pressure, and/or status indicators that tell a user if the system 1 is ready to be loaded, is in use, is ready to be emptied, etc. In some embodiments, this information can be relayed across a fully automated system without a human operator. The control system 750 can monitor time and/or temperature and/or pressure of the system 1 and/or vessel 100 to determine, based on its measurements, when to end the operating sequence of FIG. 5, according to some embodiments. In some embodiments, the control system can maintain set parameters for a defined operating sequence, according to FIG. 5, that has been determined to effectively remove contaminants from the contaminated soil.

Stage 602 occurs after the contaminated soil is loaded according to Step 501, according to some embodiments. In Stage 602, corresponding with Step 502, the heat source 300 and vacuum pump 400 are activated to apply heat and pressure to the vessel 100, respectively. As the heat source 300 is applied to the vessel 100, the temperature in the vessel cavity 110 increases to a first defined temperature, which can be a temperature within an accepted range, a temperature exceeding a minimum value, or a precise temperature. As the vacuum pump 400 is applied to the system 1, the pressure is reduced to a first defined pressure, which can be a pressure within an accepted range, a pressure below a minimum value, or a precise pressure. In some embodiments, the first defined temperature is about equal to or greater than 325 Kelvin and the first defined pressure is about or substantially equal to or less than 0.001 Torr.

In Stage 603, the temperature and pressure of the vessel cavity 110 is maintained, and the agitation source 200 is also activated in accordance with Step 505, according to some embodiments. “Maintained” indicates that the vessel 100 stays at the defined temperature and defined pressure during the Stage 603 or otherwise defined time.

The application of heat, pressure, and agitation causes the contaminants to volatize from the contaminated soil load, into the empty space of the vessel cavity 110, and into the volatile output line 700 during Stage 603. The energy from the heat source 300 causes the volatilization of contaminants. This may require a constant input of energy from the heat source 300 to keep the vessel cavity 110 at the first defined temperature during volatilization. This may also require the vacuum pump 400 to constantly decrease the pressure inside the vessel cavity 110 because, as contaminants evaporate into the vessel cavity 110, the pressure of the vessel cavity 110 would otherwise increase. In some cases, the system may monitor energy input to determine process parameters. For example, the system may monitor the energy input to determine when a volatilization has completed and/or other information about the extraction process. Additionally, or alternatively, the system may monitor a vacuum input, and changes in the vacuum levels can be used to determine information about the extraction process, e.g., end of a volatilization phase.

According to some embodiments, the temperature of the vessel 100 and the pressure of the soil remediation system 1 are monitored using at least one temperature sensor 230 and at least one pressure sensor 730. According to some embodiments, at least one temperature sensor 230 and at least one pressure sensor 730 are monitored using the control system 750, for example as described under Stage 601.

In Stage 604, the heat source 300, vacuum pump 400, and agitation source 200 are still applied to the vessel 100 and/or system 1 according to some embodiments. According to some embodiments, when all contaminants that can be volatized at the first defined temperature and first defined pressure are volatized, the heat source 300 and vacuum pump 400 require less energy to maintain the first defined temperature and first defined pressure.

In some embodiments, the temperature of the vessel 100 may increase and the pressure in the system 1 may decrease. The increase in vessel 100 temperature can indicate that the contaminants have volatilized because the heat source 300 causes the vessel temperature to increase instead of supplying energy for contaminants to undergo a phase change to a volatilized, gaseous state. According to some embodiments, the temperature can be increased to a second defined temperature and the pressure can be decreased to a second defined pressure to accommodate multiple contaminants at various optimal temperatures and pressures for each contaminant's volatilization. In some embodiments, the process occurs at only the first defined temperature and first defined pressure. When less energy is required to maintain the first defined temperature and first defined pressure, or after the temperature of the vessel 100 begins to increase, Stage 604 is continued for a defined extension time to allow a sufficient amount for the contaminants to volatilize out of the contaminated soil load. In some embodiments, the time may be based on the type of contaminate(s) and processing factors, e.g., amount of heat, vacuum level, amount of soil in the vessel, and so on. In some embodiments, the extension time may be determined empirically, for example based on test runs or other experimental factors which can be performed to determine the operating parameters for the system.

After the defined extension time has concluded, volatiles are considered to be sufficiently removed from the contaminated soil load and the heat source 300, vacuum pump 400, and agitation source 200 are deactivated in Stage 605, according to some embodiments and corresponding with Step 507 in FIG. 5. According to some embodiments, the control panel 750 can display that the operation has concluded. In some embodiments, the system 1 returns to atmospheric pressure and then the remediated soil can be expelled from the vessel cavity 110 and the condensed contaminants can be removed from the volatile collection tank 800, corresponding with Step 508 in FIG. 5. If the soil remediation system 1 is not used again, over time, the vessel 100 will return to atmospheric temperature. In some embodiments, this is facilitated by opening the door 140.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

What is claimed is:

1. A system for restoring a contaminated soil, the system comprising:
a first vessel configured to receive the contaminated soil;
an agitator configured to disturb the contaminated soil;
a heat source configured to heat the contaminated soil; and
a vacuum pump coupled to the first vessel, wherein the coupling enables an evaporated contaminant to escape from the first vessel.

2. The system of claim 1, wherein the agitator disturbs the contaminated soil by rotation.

3. The system of claim 1, further comprising an insulation on the first vessel.

4. The system of claim 1, wherein the first vessel comprises at least one fin that protrudes into the first vessel.

5. The system of claim 1, wherein the first vessel comprises at least one temperature sensor.

6. The system of claim 1, wherein the first vessel comprises at least one pressure sensor.

7. The system of claim 1, further comprising a control system configured to coordinate operation of the system.

8. The control system of claim 7, wherein the control system is configured to monitor an internal temperature and an internal pressure of the system over time.

9. The system of claim 1, wherein the vacuum pump is a dry pump.

10. The system of claim 1, further comprising a second vessel coupled to the vacuum pump to contain the evaporated contaminant.

11. A system for removing contaminants from a contaminated soil, the system comprising:
a first vessel configured to receive the contaminated soil and to agitate the contaminated soil;
a heat source configured to heat the contaminated soil; and
a vacuum pump coupled to the first vessel, wherein the coupling enables an evaporated contaminant to escape from the first vessel.

12. The system of claim 11, wherein the vacuum pump is a dry vacuum pump dynamically sealed to the first vessel.

13. The system of claim 11, wherein the dry vacuum pump is coupled to the first vessel and a second vessel and causes the evaporated contaminant to be transported from the first vessel to the second vessel.

14. A method for restoring a contaminated soil, the method comprising:
loading the contaminated soil into a first vessel;
applying a heat to the contaminated soil in the first vessel;
applying a vacuum pump to the first vessel to reduce a pressure within the first vessel;
maintaining the heat and the reduced pressure for a defined duration;
agitating the contaminated soil during the defined duration; and
removing an evaporated contaminant from the first vessel.

15. The method of claim 14, wherein applying the vacuum pump to the first vessel to reduce the pressure within the first vessel comprises reducing the pressure to 0.001 Torr.

16. The method of claim 14, wherein applying the heat to the contaminated soil in the first vessel comprises causing the contaminated soil to be heated to a temperature equal to or greater than 325 Kelvin.

17. The method of claim 14, wherein the evaporated contaminant is condensed to form a liquid contaminant in a second vessel.

18. The method of claim 14, wherein agitating the contaminated soil during the defined duration causes the contaminated soil to turnover, wherein turnover maximizes the volatilization of the contaminant out of the soil forming the evaporated contaminant during the defined duration.

19. The method of claim 14, wherein:
the reduced pressure is applied using a dry vacuum pump; and
the dry vacuum pump is fluidly coupled to the first vessel and a second vessel and causes the evaporated contaminant to be transported from the first vessel to the second vessel.
